(19) United States
(12) Patent Application Publication
(10) Pub. No.: US 2022/0333258 A1
(43) Pub. Date: Oct. 20, 2022

(54) ELECTRODE FOR HIGH-PERFORMANCE ALKALINE WATER ELECTROLYSIS, AND MANUFACTURING METHOD THEREFOR

(71) Applicant: Chungbuk National University Industry-Academic Cooperation Foundation, Chungcheongbuk-do (KR)

(72) Inventors: Jong Hoon JOO, Chungcheongbuk-do (KR); Hye Ri KIM, Chungcheongbuk-do (KR); Ga Hyeon LEE, Chungcheongbuk-do (KR)

(21) Appl. No.: 17/753,136

(22) PCT Filed: May 27, 2021
(86) PCT No.: PCT/KR2021/006612

§ 371 Date: Feb. 21, 2022

(30) Foreign Application Priority Data
May 29, 2020 (KR) 10-2020-0065437
Jan. 15, 2021 (KR) 10-2021-0006026

(51) Int. Cl. C25B 11/031; C25B 11/089; C25B 11/075; C25B 1/04

(52) U.S. Cl. CPC C25B 11/031; C25B 11/089; C25B 11/075; C25B 1/04

(57) ABSTRACT

Disclosed is a method for manufacturing an electrode for alkaline water electrolysis, the method including: dissolving a metal salt in a solvent, followed by synthesis, to prepare a wet powder; performing an oxidative heat treatment on the wet powder; and performing a reductive heat treatment on the oxidatively heat treated powder.

### CROSS-REFERENCE TO RELATED APPLICATIONS

This patent application is a national phase filing under section 371 of International Application No. PCT/KR2021/006612, filed on May 27, 2021, which claims the priority of Korean Application No. 10-2021-0006026, filed on Jan. 15, 2021, and Korean Application No. 10-2020-0065437, filed on May 29, 2020, which applications are hereby incorporated herein by reference.

### TECHNICAL FIELD

The present disclosure relates to a high-performance electrode for alkaline water electrolysis and a manufacturing method therefor.

### BACKGROUND

In recent years, the development scale of renewable energy, such as wind power and solar power, has been continuously increasing in developed countries around the world, and thus the need for large-capacity energy storage is increasing as a measure to solve problems, such as a decrease in utilization of renewable power, occurring due to the resulting unpredictability and volatility thereof. As the sulfur tolerance for diesel and gasoline has been lowered due to global environmental protection policies, the market size of hydrogen has been constantly growing every year, and hydrogen is used in various industrial fields, for example, the production of metals or semiconductors and the synthesis of compounds such as ammonia. Hydrogen can be produced from hydrocarbons or water by hydrogen extraction through methods, such as steam reforming, auto-thermal reforming, partial oxidation, thermochemical water splitting, direct cracking, biological decomposition, and electrolysis.

Water electrolysis refers to the electrolysis of pure water to produce hydrogen. Water electrolysis is a technology that can currently respond to the increasing demand for hydrogen and has a purpose of large-capacity power storage for the storage of renewable energies, such as wind power and solar light. Hydrogen has advantages of having high energy density, being stably storable for a long period of time, and being storable in various forms, such as gas and liquid. Water electrolysis techniques are classified into alkaline water electrolysis, polymer electrolyte membrane water electrolysis, and high-temperature water electrolysis.

As for alkaline water electrolysis, hydrogen and oxygen are produced from a cathode and an anode at a molar ratio of 1:2, respectively, through the electrochemical reaction by using an anion transport liquid electrolyte, such as potassium hydroxide (KOH) or sodium hydroxide (NaOH). Current commercial alkaline water electrolysis systems show low efficiency due to the increase in resistance inside systems during high-current operation and repeated on/off operation and the decreases in electrode activity and durability due to hydrogen and oxygen gas evolution reactions in electrodes. However, anion transport catalysts are high in oxygen reduction rate and thus use transition metals (Ni, Co, Fe, etc.) as electrode catalysts instead of using noble metals, such as Pt, thereby increasing electrode activity and efficiency, leading to the production of a large amount of hydrogen. For the improvement of alkaline water electrolysis techniques, it is necessary to develop materials for electrodes and catalysts having excellent electrode/electrolyte interfacial characteristics and superior stability and activity and manufacturing methods for the same, and the stability of electrodes and catalysts is an important factor for attaining long operating lifespan.

However, research on electrodes for alkaline water electrolysis has been focused on the deposition of catalysts on substrates until now. Catalyst materials are mainly used by being deposited on a substrate through electroplating, electrophoresis, physical vapor deposition (PVD), chemical vapor deposition (CVD), a binder, or the like, wherein the deposition method varies depending on the catalyst material and thus the selection of materials is restricted depending on the deposition method. Especially, the large-area/mass production technology to achieve commercialization requires large investments in facilities/equipment, and catalyst deposition methods considering such situations need to be developed. In other words, there is a need for a method for manufacturing an electrode for alkaline water electrolysis, wherein the mass production and large area of the electrode, as essential factors for the commercialization of alkaline water electrolysis, can be attained, and the electrode employs various transition metals and thus has durability during high-current operation and repeated on/off operation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the linear sweep voltammetry (LSV) measurement results of electrodes according to a comparative example and an example.

FIG. 2 depicts the SEM images of electrodes according to various examples of the present disclosure.

FIG. 3 shows the LSV measurement results of electrodes according to various examples of the present disclosure

FIG. 4 shows the double layer capacitance measurement results of electrodes according to various examples of the present disclosure.

FIG. 5 depicts the SEM images of electrodes at different temperatures according to various examples of the present disclosure.

FIG. 6 shows the LSV measurement results of electrodes at different temperatures according to various examples of the present disclosure.

FIG. 7 shows the double layer capacitance measurement results of electrodes at different temperatures according to various examples of the present disclosure.

FIG. 8A is a schematic diagram showing a manufacturing method for a porous NiFe catalyzed substrate (CS) according to an example of the present disclosure; FIG. 8B shows the X-ray diffraction (XRD) analysis results for investigating the crystalline structures of NiₓFe₁₋ₓ; FIG. 8C shows a selected area electron diffraction (SAED) pattern of Ni_{0.7}Fe_{0.3-}CS, with a TEM image as an insert image; and FIG. 8D depicts EDS element mapping images.

FIG. 9A is a graph of linear sweep voltammetry (LSV) measurement in HER of NiₓFe₁₋ₓ; FIG. 9B is a graph of LSV measurement in OER; FIG. 9C is a graph comparing the overpotentials for HER and OER; and FIG. 9D is a table comparing HER and OER activities of Ni_{0.7}Fe_{0.3-}CS and conventional various NiFe substrate bidirectional catalyst electrodes.

FIG. 10A is a graph of linear sweep voltammetry (LSV) measurement in HER of Ni_{0.7}Fe_{0.3}, Ni plate, Ni foam, and Pt plate; and FIG. 8B is a graph of LSV measurement in OER thereof.

FIG. 11 shows electrochemical impedance spectroscopy (EIS) of NiₓFe₁₋ₓ electrodes with different compositions in HER.

FIG. 12 shows electrochemical impedance spectroscopy (EIS) of NiₓFe₁₋ₓ electrodes with different compositions in OER.

FIG. 13 shows the double layer capacitance measurement results for NiₓFe₁₋ₓ electrodes with different compositions.

FIG. 14A shows polarization curves of Ni_{0.7}Fe_{0.3} and conventional various catalysts in HER; FIG. 14B shows polarization curves in OER; FIG. 14C shows polarization curves in the stationary electrode system and the RDE system; FIG. 14D is a graph comparing current densities in HER and OER at an overpotential of 280 mV; FIG. 14E shows a Tafel plot of Ni_{0.7}Fe_{0.3-}CS; FIG. 14F shows the Nyquist plot of Ni_{0.7}Fe_{0.3-}CS in HER and OER, with an enlarged EIS curve in an insert image; and FIG. 14G shows chronopotentiometric curves of Ni_{0.7}Fe_{0.3-}CS at different current densities.

FIG. 15 is a graph comparing the theoretical and experimentally measured amounts of gases in HER and OER of Ni_{0.7}Fe_{0.3} according to the time.

FIG. 16A is a TEM image of a fresh sample of Ni_{0.7}Fe_{0.3-}CS; FIG. 16B is a TEM image after OER, with a SAED pattern as an insert image; FIG. 16C is a TEM image after HER, with a SAED pattern in an insert image; FIGS. 16D to 16F show XPS spectra; FIG. 16G shows the results of double layer capacitance measurement; and FIG. 16H is a graph comparing double layer capacitances (Cdl).

FIG. 17A depicts a TEM image of Ni_{0.7}Fe_{0.3-}CS after OER; FIG. 17B shows a SAED pattern; and FIG. 17C shows the Ni/Fe ratio.

FIG. 18A depicts EDS element mapping images of Ni_{0.7}Fe_{0.3-}CS after HER; and FIGS. 18B and 18C show the Ni/Fe ratios.

FIG. 19 shows the Raman spectroscopy results of Ni_{0.7}Fe_{0.3-}CS.

FIG. 20A shows the pore distribution of Ni_{0.7}Fe_{0.3-}CS; FIG. 20B shows the results of measurement of electrochemical double layer capacitance (Cdl) in HER; FIG. 20C shows the results of measurement of electrochemical double layer capacitance in OER; and FIG. 20D depicts a table comparing Cdl of Ni_{0.7}Fe_{0.3-}CS and conventional various catalysts in HER and OER.

### DETAILED DESCRIPTION OF ILLUSTRATIVE EMBODIMENTS

Hereinafter, various exemplary embodiments of the present disclosure are described with reference to the accompanied drawings. It shall be understood that exemplary embodiments and terminologies used herein are not intended to limit the technology described in the present disclosure to particular exemplary embodiments, but to cover various modifications, equivalents, and/or alternatives of corresponding exemplary embodiments.

Hereinafter, various exemplary embodiments of the present disclosure will be described in detail with reference to the accompanying drawings.

### First Exemplary Embodiment

Methods for manufacturing an electrode for alkaline water electrolysis according to various exemplary embodiments of the present disclosure may include the steps of: preparing a wet powder; performing an oxidative heat treatment; and performing a reductive heat treatment.

In the step of preparing a wet powder, a metal salt may be dissolved in a solvent, followed by synthesis, to prepare the wet powder.

The metal salt may be a salt of at least one metal selected from the group consisting of Ni, Fe, Co, Mn, Cu, Zn, Mo, Ca, Nb, W, and Ti. Specifically, the metal salt may be a hydrate of a metal salt. For example, the metal salt may be Ni(NO₃)₂.6H₂O, Fe(NO₃)₃.9H₂O, Co(NO₃).9H₂O, Mn(NO₃)₂.6H₂O, Cu(NO₃)₂.6H₂O, Zn(NO₃)₂.6H₂O, or the like.

In the step of preparing a wet powder, the wet powder may be prepared by any one method selected from the group consisting of a Pechini process, a sol-gel process, and a colloidal process. For example, when the wet powder is prepared by a Pechini process, the wet powder may be synthesized by dissolving a metal salt in distilled water as a solvent, adding a chelating agent, and adjusting the pH to 6. Citric acid or the like may be used as a chelating agent.

Then, the step of performing an oxidative heat treatment on the synthesized wet powder may be carried out. The oxidative heat treatment may be performed in air at a temperature of 300° C. to 500° C. for 30 minutes to 2 hours after the wet powder is molded in a mold. Through the oxidative heat treatment performed under such conditions, a nano-porous electrode can be ultimately manufactured.

Then, the step of performing a reductive heat treatment on the oxidatively heat treated wet powder may be carried out. The reductive heat treatment may be performed under a hydrogen atmosphere at a temperature of 400° C. to 700° C. for 1 to 4 hours. The porosity of the manufactured electrode may vary depending on the temperature of the reductive heat treatment. In the present disclosure, the average porosity of the manufactured electrode may be adjusted to 50 to 80% by the reductive heat treatment at a temperature in the above range.

Thereafter, the shape of the electrode may be controlled by further performing processes, such as dip-coating and etching.

In the present disclosure, the wet-synthesized nano-powder is molded in a mold, prepared into an oxide by an oxidative heat treatment, and then subjected to a reductive heat treatment, thereby manufacturing a metal nano-porous electrode.

The manufacturing method of the present disclosure attains a simple process, and facilitates the manufacturing of large-area electrodes by manufacturing a substrate, to which multi-element materials are applicable, and using the substrate as an electrode. In addition, synthesis can be conducted by variously applying transition metals, such as Ni, Co, Mn, Cu, Zn, and Ti, and oxide materials, and the synthesized powder is subjected to a reductive heat treatment under a hydrogen atmosphere, so that metal/ceramic composite electrodes based on oxide materials, such as alumina (Al₂O₃), zirconia (ZrO₂), and TiO₂, can be manufactured.

The electrode for alkaline water electrolysis of the present disclosure may be manufactured by the above-described method. The electrode for alkaline water electrolysis of the present disclosure may contain at least one selected from the group consisting of Ni, Fe, Co, Mn, Cu, Zn, Mo, Ca, Nb, W, and Ti and may be in a nanoporous form. Specifically, the electrode for alkaline water electrolysis of the present disclosure may contain one selected from the group consisting of Ni, Fe, Co, Mn, Cu, Zn, Mo, Ca, Nb, W, and Ti or may be an alloy of metals selected therefrom. For example, the electrode for alkaline water electrolysis of the present disclosure may be a Ni—Fe alloy, a Ni—Co alloy, and a Ni—Zn alloy.

Alternatively, the electrode for alkaline water electrolysis of the present disclosure may contain: a metal selected from the group consisting of Ni, Fe, Co, Mn, Cu, Zn, Mo, Ca, Nb, W, and Ti; and an oxide. That is, the electrode for alkaline water electrolysis of the present disclosure may be a metal/ceramic composite material. The oxide may be at least one selected from the group consisting of alumina (Al₂O₃), zirconia (ZrO₂), TiO₂, [(La₁₋ₓSrₓ)CoO_{3-δ}] (LSC), [(La₁₋ₓSrₓ)FeO_{3-δ}] (LSF), [(La₁₋ₓSrₓ)(Co_{1-y}Fe_{y})O_{3-δ}] (LSCF), [(LaₓSr₁₋ₓ)TiO_{3-δ}] (LST), [(BaₓSr₁₋ₓ)(Co_{y}Fe_{1-y})O₃] (BSCF), LaCoO₃, LaNiO₃, (LaₓSr₁₋ₓ)VO₃, Ca(VₓMo₁₋ₓ)O₃, [Ba(ZrₓCe_{y}Y_{1-(x+y)})₃] (BZCY), and [Pr(Ba₁₋ₓSrₓ)(Fe_{2-y}Ge_{y})O₆] (PBSFG). In the chemical formulas, 0<x<1, 0<y<1, and 0<δ<3. Specifically, 0<x<0.7, 0<y<0.7, and 0<δ<3.

The electrode for alkaline water electrolysis may have an average porosity of 50 to 80%. Through such a porosity, an electrode having a low overpotential, excellent durability through chemical stability, and a wide specific surface area can be secured.

Hereinafter, the present disclosure will be described in detail with reference to the examples. However, the following examples are merely for illustrating the present disclosure and are not intended to limit the scope of the present disclosure.

### Example 1

A nitrate hexahydrate, that is, at least one of Ni(NO₃)₂.6H₂O, Fe(NO₃)₃.9H₂O, Co(NO₃).6H₂O, and Zn(NO₃)₂.6H₂O was dissolved in distilled water, followed by synthesis according to the molar ratios in Table 1. Citric acid, which plays as a chelating agent facilitating synthesis, was added to the solutions to which the multi-element nitrates were added, and synthesis was conducted by adjusting the pH to 6 using ammonia water. Thereafter, for electrode manufacturing, the powder synthesized through a wet process was molded, subjected to an oxidative heat treatment (Air, 400° C., 1 h), and then subjected to a reductive heat treatment under a hydrogen atmosphere for 3 hours, wherein the temperature of reductive heat treatment was varied according to Table 1 below.

TABLE 1

| | Molar | Temperature of reductive | Porosity |
|---|---|---|---|
| | ratio | heat treatment (° C.) | (%) |
| Comparative Example | — | — | 6 |
| (Ni sandblast substrate) | | | |
| Example 1-1 (Ni) | — | 450 | 63 |
| Example 1-2 (Ni) | — | 650 | 58 |
| Example 1-3 (Ni—Fe) | 5:5 | 450 | 74 |
| Example 1-4 (Ni—Fe) | 5:5 | 550 | 60 |
| Example 1-5 (Ni—Fe) | 5:5 | 650 | 57 |
| Example 1-6 (Ni—Co) | 5:5 | 650 | 57 |
| Example 1-7 (Ni—Zn) | 5:5 | 650 | 72 |

Table 1 shows the porosities of the Ni sandblast substrate typically used as a substrate for an electrode for alkaline water electrolysis and the substrates manufactured according to examples of the present disclosure. Referring to Table 1, the porosities of the electrodes manufactured according to the examples were much higher than that of the commercialized Ni sandblast substrate as a comparative example.

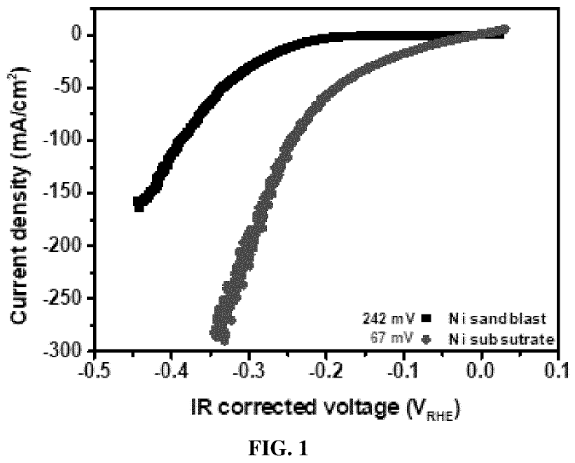

FIG. 1 shows a graph of linear sweep voltammetry (LSV) measurement of the Ni sandblast and an electrode manufactured according to example 1-1 and the overpotentials (η@10 mA/cm2) thereof. It can be identified that compared with the Ni sandblast as a comparative example, the Ni substrate electrode manufactured through the example showed better performance and had a lower overpotential at the same current density (10 mA/cm2).

As can be confirmed from Table 1 and FIG. 1, the wide specific surface area of the Ni electrode of Example 1-1 having a higher porosity than the comparative example can further improve the performance of existing electrodes, suggesting the possibility of further improving the performance of electrodes compared with the performance of existing electrodes when the electrodes were manufactured by applying various materials, such as metal oxides and oxides including perovskite and spinel structures, in the manufacturing method of the present disclosure.

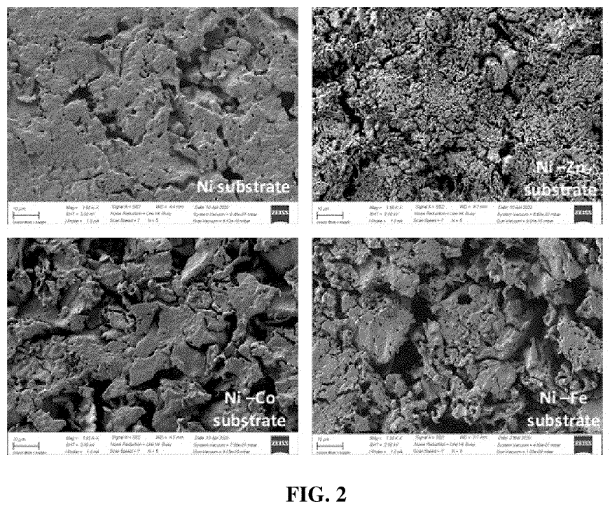

FIG. 2 depicts SEM images of the electrodes of Examples 1-2 (Ni), 1-5 (Ni—Fe), 1-6 (Ni—Co), and 1-7 (Ni—Zn), for which the temperature of reductive heat treatment was 650° C., among the examples of the present disclosure. Like in Table 1, the porosities of the respective electrodes were higher than that of the electrode of the comparative example.

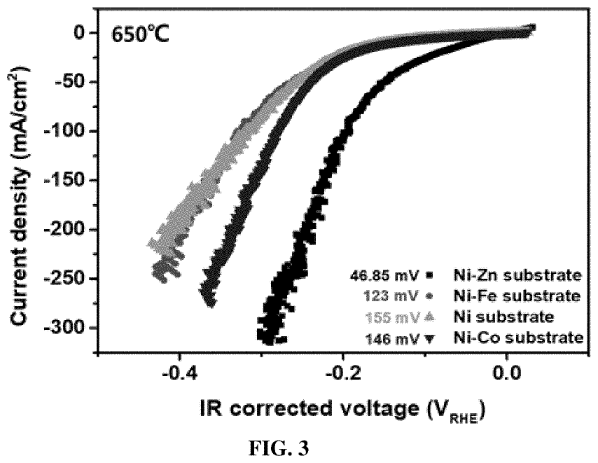

FIG. 3 shows the LSV measurement results of the electrodes of Examples 1-2 (Ni), 1-5 (Ni—Fe), 1-6 (Ni—Co), and 1-7 (Ni—Zn), for which the temperature of reductive heat treatment was 650° C., among the examples of the present disclosure. Referring to FIG. 3, multi-element electrodes allowing various combinations can be manufactured by the manufacturing method of the present disclosure. In addition, a low overpotential was shown in the order of the electrodes of Example 1-7 (Ni—Zn) <Example 1-5 (Ni—Fe) <Example 1-6 (Ni—Co) <Example 1-2 (Ni), and it can be therefore seen that electrodes with excellent performance can be realized by combining various materials.

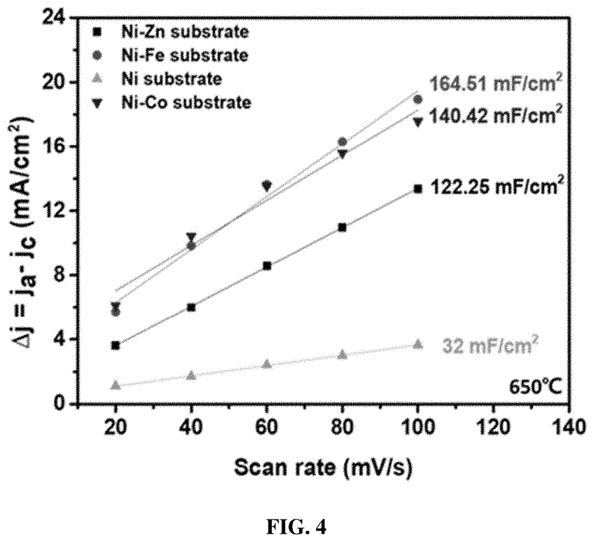

FIG. 4 is a graph showing the oxidation and reduction current density difference according to the scan rates (20, 40, 60, 80, 100 mV/s) of the multi-element substrate electrodes in a region of −0.2 V Hg/HgO (HER basis). Equation 1 below is an expression showing the relationship between the oxidation and reduction current density difference and the double layer capacitance in cyclic voltammetry (CV) according to the electric double layer capacitance and the scanning rate.

Δj=vC_{dl} [Equation 1]

As a result of calculating the double layer capacitance to obtain the actual electrochemical active area of an electrode, the active areas of the electrodes manufactured according to the examples of the present disclosure were larger than that of the conventional electrode of the comparative example. This shows the results corresponding to the SEM images of the manufactured multi-element substrate electrodes in FIG. 2.

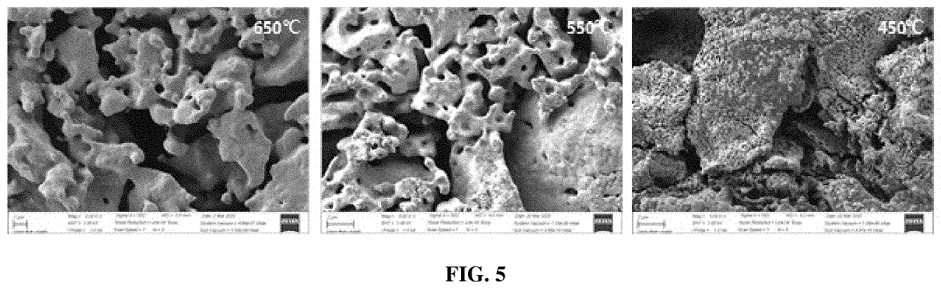

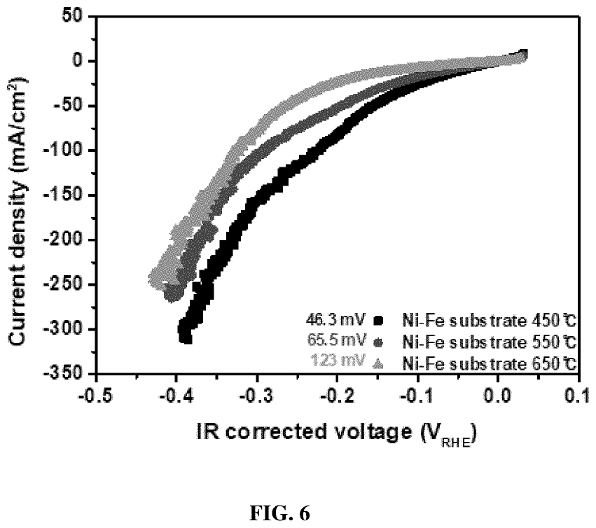

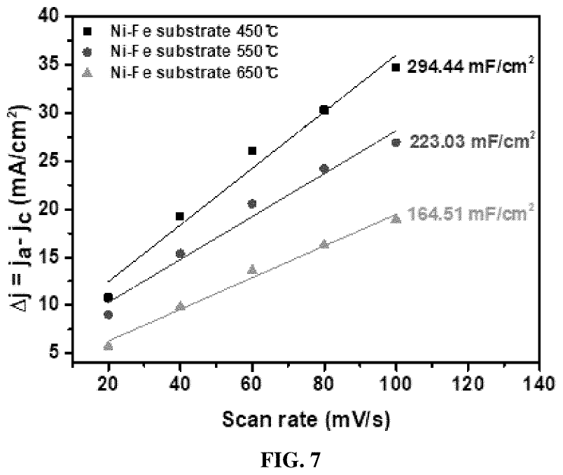

FIG. 5 depicts SEM images of the Ni—Fe electrodes manufactured according to Examples 1-3, 1-4, and 1-5 at different temperatures, and FIG. 6 shows the LSV measurement results therefrom. As a result of LSV measurement, Examples 1-3, 1-4, and 1-5 showed overpotentials of 46.3 mV (@10 mA, 450° C.), 65.5 mV (@10 mA, 550° C.), and 123 mV (@10 mA, 650° C.), respectively. Referring to FIG. 7, it was considered that the sites involved in the electrode reactions can be controlled by adjusting the temperature of reductive heat treatment.

Therefore, through the experimental results using the examples of the present disclosure, it can be seen that various process variables capable of improving the performance of electrodes, such as elements, the temperature of reduction, and reaction sites, can be controlled, and furthermore, the possibility of improving the manufacturing and performance of electrodes was presented by additionally grafting various processes, such as dip coating and etching.

### Second Exemplary Embodiment

A method for manufacturing an electrode for alkaline water electrolysis according to still another exemplary embodiment of the present disclosure may include the steps of: dissolving a metal salt in a solvent, followed by synthesis, to prepare a wet powder; gelling the wet powder; performing a low-temperature heat treatment on the gel to prepare a char; molding the char to manufacture a substrate; performing an oxidative heat treatment on the substrate; and performing a reductive heat treatment on the substrate.

In the step of preparing a wet powder, a metal salt may be dissolved in a solvent, followed by synthesis, to prepare the wet powder.

The metal salt may be a salt of at least one metal selected from the group consisting of Ni, Fe, Co, Mn, Cu, Zn, Mo, Ca, Nb, W, and Ti. Specifically, the metal salt may be a hydrate of a metal salt. For example, the metal salt may be Ni(NO₃)₂.6H₂O, Fe(NO₃)₃.9H₂O, Co(NO₃).6H₂O, Mn(NO₃)₂.6H₂O, Cu(NO₃)₂.6H₂O, Zn(NO₃)₂.6H₂O, or the like.

In the step of preparing a wet powder, the wet powder may be prepared by any one method selected from the group consisting of a Pechini process, a sol-gel process, and a colloidal process. For example, when the wet powder is prepared by a Pechini process, the wet powder may be synthesized by dissolving a metal salt in distilled water as a solvent, adding a chelating agent, and adjusting the pH to 6. Citric acid or the like may be used as a chelating agent.

Then, the step of gelling the wet powder may be carried out. The gelling may be performed with stirring at 70° C. to 90° C. for 5 hours to 9 hours. The wet powder may be gelled by treatment under such conditions.

Then, the gel may be prepared into a char by a low-temperature heat treatment. The step of preparing into the char may be carried out at 300° C. to 700° C. for 30 minutes to 2 hours. The gel may be prepared into an ash form by heat treatment under such conditions.

Then, the char may be molded to manufacture a substrate. Specifically, the char may be placed in a mold and pressed at 1000 to 2000 MPa to be prepared into a pellet form.

Then, the step of performing an oxidative heat treatment on the substrate may be carried out. The oxidative heat treatment may be performed in air at a temperature of 300° C. to 700° C. for 30 minutes to 2 hours. Through the oxidative heat treatment under such conditions, spaces where organic residues have been placed may become pores, thereby increasing the electric active area of the substrate.

Then, the step of performing a reductive heat treatment on the oxidatively heat treated substrate may be carried out. The reductive heat treatment may be performed under a hydrogen atmosphere at a temperature of 400° C. to 700° C. for 1 to 4 hours. Through the reduction heat treatment, oxygen vacancies may be formed into nano-pores. In the present disclosure, through the low-temperature heat treatment whereby hydroxyl (OH) species cannot be completely removed, hydroxyl species can remain on the surface of the substrate to improve the water splitting performance. The porosity of the manufactured electrode may vary depending on the temperature of the reductive heat treatment. In the present disclosure, the average porosity of the manufactured electrode may be adjusted to 50 to 80% by the reductive heat treatment at a temperature in the above range.

Thereafter, the shape of the electrode may be controlled by further performing processes, such as dip-coating and etching.

In the present disclosure, the wet-synthesized nano-powder is gelled, prepared into a char, molded in a mold, and then subjected to an oxidative heat treatment and a reductive heat treatment, thereby manufacturing a nanoporous metal electrode.

The manufacturing method of the present disclosure attains a simple process, and facilitates the manufacturing of large-area electrodes by manufacturing a substrate, to which multi-element materials are applicable, and using the substrate as an electrode. In addition, synthesis can be conducted by variously applying transition metals, such as Ni, Co, Mn, Cu, Zn, and Ti, and oxide materials, and the synthesized powder is subjected to a reductive heat treatment under a hydrogen atmosphere, so that metal/ceramic composite electrodes based on oxide materials, such as alumina (Al₂O₃), zirconia (ZrO₂), and TiO₂, can be manufactured.

The electrode for alkaline water electrolysis of the present disclosure may be manufactured by the above-described method. The electrode for alkaline water electrolysis of the present disclosure may contain at least one selected from the group consisting of Ni, Fe, Co, Mn, Cu, Zn, Mo, Ca, Nb, W, and Ti and may be in a nano-porous form. Specifically, the electrode for alkaline water electrolysis of the present disclosure may contain at least one selected from the group consisting of Ni, Fe, Co, Mn, Cu, Zn, Mo, Ca, Nb, W, and Ti or may be an alloy of metals selected therefrom. For example, the electrode for alkaline water electrolysis of the present disclosure may be a Ni—Fe alloy, a Ni—Co alloy, and a Ni—Zn alloy. Preferably, the electrode for alkaline water electrolysis of the present disclosure may be Ni—Fi alloys controlled to have various molar ratios. For example, the electrode for alkaline water electrolysis of the present disclosure may contain NixFe1−x in which x>0.5. More specifically, the molar ratio of Ni and Fe may be 9:1 to 7:3. Through such a molar ratio, the electrode shows a lower overpotential at the same current density for the oxygen evolution reaction (OER) and hydrogen evolution reaction (HER), and thus can have excellent characteristics.

When the electrode for alkaline water electrolysis of the present disclosure is used as an anode, an amorphous hydroxyl layer may be generated during OER. Therefore, the amorphous hydroxyl layer may be included after OER.

When the electrode for alkaline water electrolysis of the present disclosure is used as a cathode, a layered double hydroxide (LDH) may be generated during HER. Therefore, the layered double hydroxide may be included after HER.

The electrode for alkaline water electrolysis of the present disclosure may contain: a metal selected from the group consisting of Ni, Fe, Co, Mn, Cu, Zn, Mo, Ca, Nb, W, and Ti; and an oxide. That is, the electrode for alkaline water electrolysis of the present disclosure may be a metal/ceramic composite material. The oxide may be at least one selected from the group consisting of alumina (Al₂O₃), zirconia (ZrO₂), TiO₂, MgO, CaO, BaO, SiO₂, Y₂O₃, CeO₂, [(La₁₋ₓSrₓ)CoO_{3-δ}] (LSC), [(La₁₋ₓSrₓ)FeO_{3-δ}] (LSF), [(La₁₋ₓSrₓ)(Co_{1-y}Fe_{y})O_{3-δ}] (LSCF), [(LaₓSr₁₋ₓ)TiO_{3-δ}] (LST), [(BaₓSr₁₋ₓ)(Co_{y}Fe_{1-y})O₃] (BSCF), LaCoO₃, LaNiO₃, (LaₓSr₁₋ₓ)VO₃, Ca(VₓMo₁₋ₓ)O₃, [Ba(ZrₓCe_{y}Y_{1-(x+y)})O₃] (BZCY), and [Pr(Ba₁₋ₓSrₓ)(Fe_{2-y}Ge_{y})O₆] (PBSFG). In these chemical formulas, 0<x<1, 0<y<1, and 0<δ<3. Specifically, 0<x<0.7, 0<y<0.7, and 0<δ<3.

The electrode for alkaline water electrolysis may have an average porosity of 50 to 80%. Through such a porosity, an electrode having a low overpotential, excellent durability through chemical stability, and a wide specific surface area can be secured.

Hereinafter, the present disclosure will be described in detail with reference to the examples. However, the following examples are merely for illustrating the present disclosure and are not intended to limit the scope of the present disclosure.

### Example 2

Nickel nitrate hexahydrate (Ni(NO₃)₂.6H₂O) and iron nitrate monohydrate (Fe(NO₃)₃.9H₂O) were dissolved in distilled water according to the molar ratios in Table 2, followed by synthesis using a wet manufacturing process. Citric acid (99.5%, Kanto chemical Co., Inc), which plays as a chelating agent facilitating synthesis, was added to the solutions to which the multi-element nitrates were added, and synthesis was conducted by adjusting the pH to 6 using ammonium hydroxide. The obtained mixture was stirred at 80° C. for 7 hours to generate a gel, and then the gel was heated in air at 400° C. for 1 hour to generate char containing a nickel-iron oxide. The char powder was prepared into pellets by pressing at 1370 MPa, followed by an oxidative heat treatment (400° C., 1 h, P(O₂)≈0.21 atm) and then a reductive heat treatment under a hydrogen atmosphere for 3 hours (450° C., 3 h, P(O₂)≈10⁻²² atm).

TABLE 2

| | Molar | temperature of reductive | Porosity |
|---|---|---|---|
| | ratio | heat treatment (° C.) | (%) |
| Comparative Example | — | — | 6 |
| (Ni sandblast substrate) | | | |
| Example 2-1 (Ni) | — | 450 | 63 |
| Example 2-2 (Ni—Fe) | 9:1 | 450 | 64 |
| Example 2-3 (Ni—Fe) | 7:3 | 450 | 73 |
| Example 2-4 (Ni—Fe) | 5:5 | 450 | 74 |
| Example 2-5 (Ni—Fe) | 3:7 | 450 | 79 |
| Example 2-6 (Ni—Fe) | 1:9 | 450 | 76 |

Table 2 above shows the porosities of the Ni sandblast substrate typically used as a substrate of an electrode for alkaline water electrolysis and the substrates manufactured according to example 2 of the present disclosure. Referring to Table 2, the porosities of the electrodes manufactured according to the examples were much higher than that of the commercialized Ni sandblast substrate as a comparative example.

### Experimental Example 1—Morphology Analysis

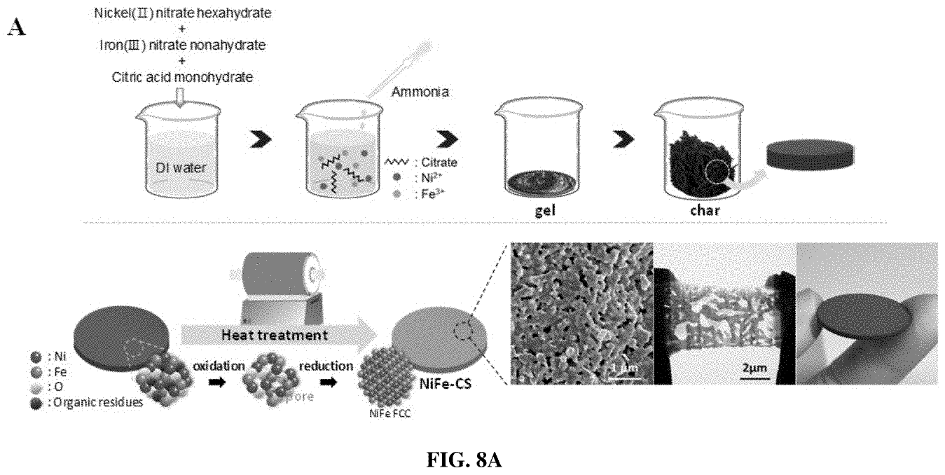

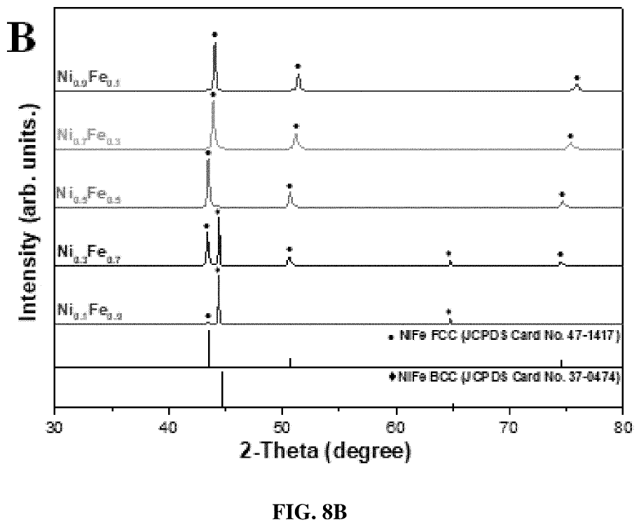

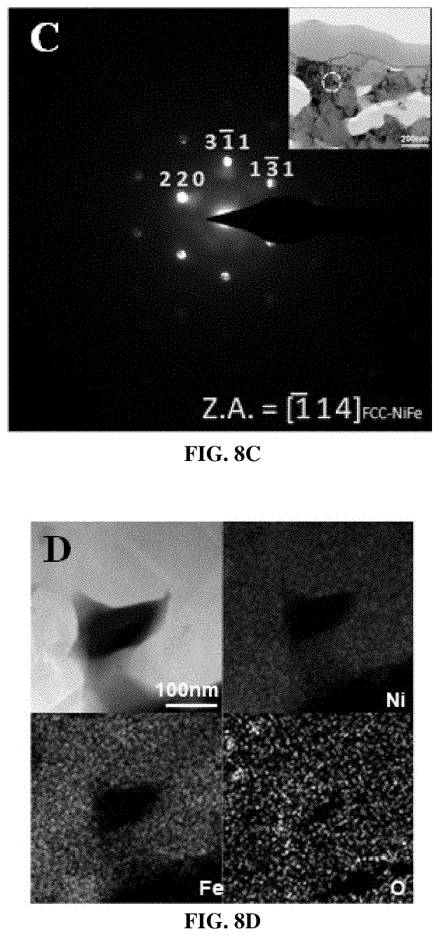

FIG. 8B shows the X-ray diffraction (XRD) analysis results for investigating the crystalline structures of NiₓFe₁₋ₓ. Referring to FIG. 8B, Ni_{0.9}Fe_{0.1} and Ni_{0.7}Fe_{0.3} showed a face-centered cubic (FCC) structure having three distinctive diffraction peaks (JCPDS Card No. 47-1417). As can be seen from FIG. 8B, the diffraction peaks of Ni_{0.9}Fe_{0.1}, Ni_{0.7}Fe_{0.3}, and Ni_{0.5}Fe_{0.5} shifted to be negative as the Fe content increased. This may attribute to the lattice expansion occurring due to the replacement of Ni atom with Fe atom. In Ni_{0.3}Fe_{0.7} and Ni_{0.1}Fe_{0.9}, peaks due to a body-centered cubic (BCC) structure were shown when the proportion of Fe increased, and this may attribute to the formation of the BCC-structured phase by the solubility limitation of Fe in the Ni—Fe alloy.

The crystalline structures of NixFe1−x were identified by the selected area electron diffraction (SEAD) pattern shown in FIG. 8C. The [114] zone axis in the diffraction image clearly showed the presence of the aligned FCC structure. These results were consistent with the XRD analysis results confirming the FCC phase.

Referring to the insert image of FIG. 8C and FIG. 8D, Ni and Fe were shown to be uniformly distributed on electrodes.

### Experimental Example 2—Electrochemical Characterization

In the present disclosure, the examples with different molar ratios were analyzed for the activities of HER and OER.

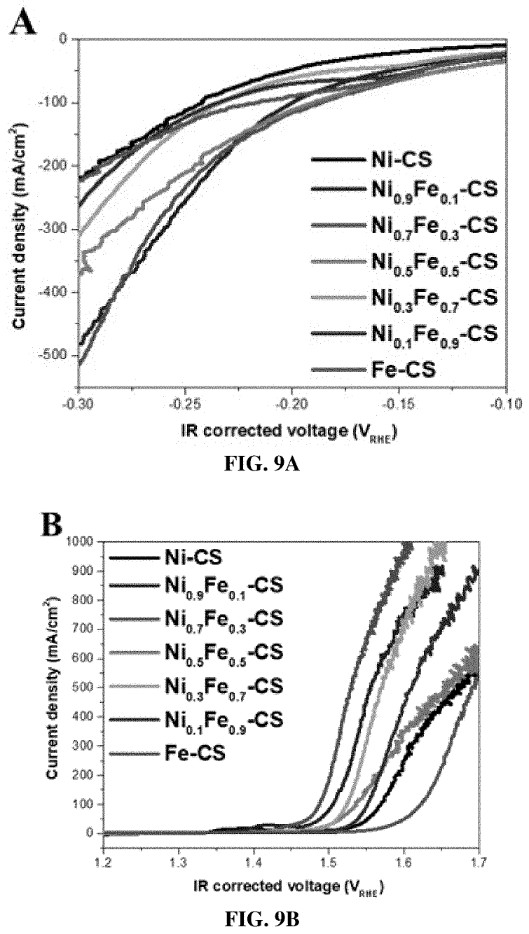

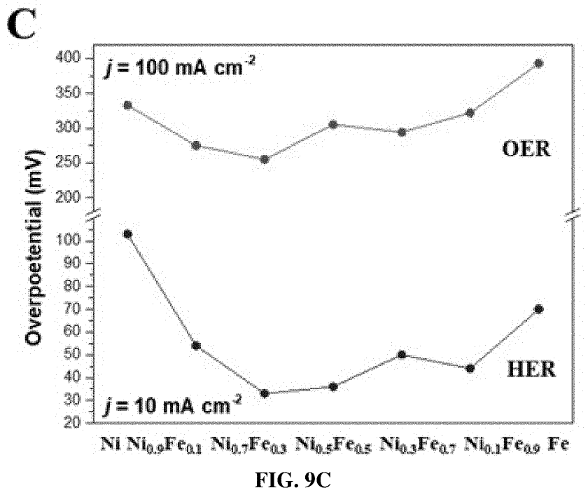

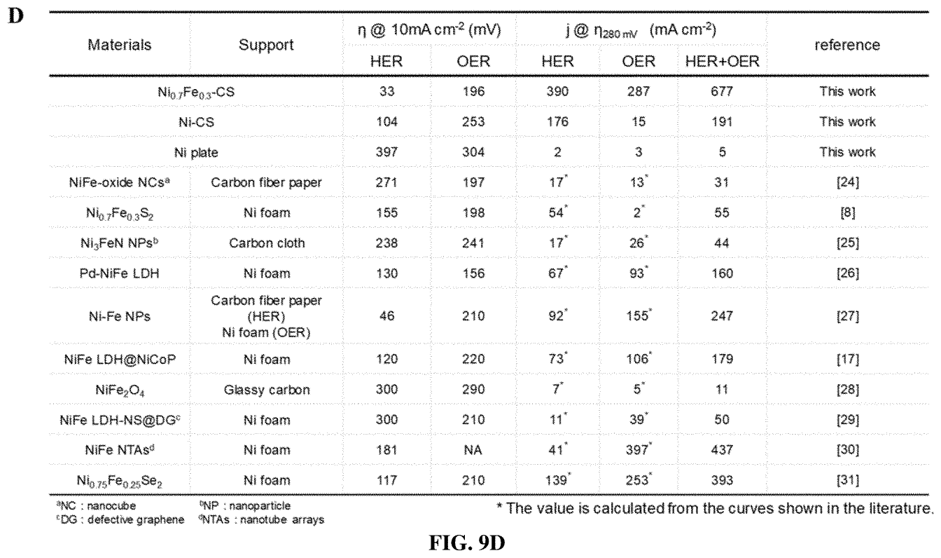

Referring to FIGS. 9A to 9C, Ni_{0.9}Fe_{0.1}-catalyzed substrate (CS) and Ni_{0.7}Fe_{0.3}-CS among the examples showed the highest performances compared with examples with different molar ratios. Especially, Ni_{0.9}Fe_{0.1}-CS showed a lower overpotential at the same current density and the highest activity in HER and OER.

Referring to FIG. 9D, Ni_{0.7}Fe_{0.3}-CS showed significantly low overpotentials (η) of 33 mV and 196 mV at a current density (j) of 10 mA cm-2 for HER and OER, respectively.

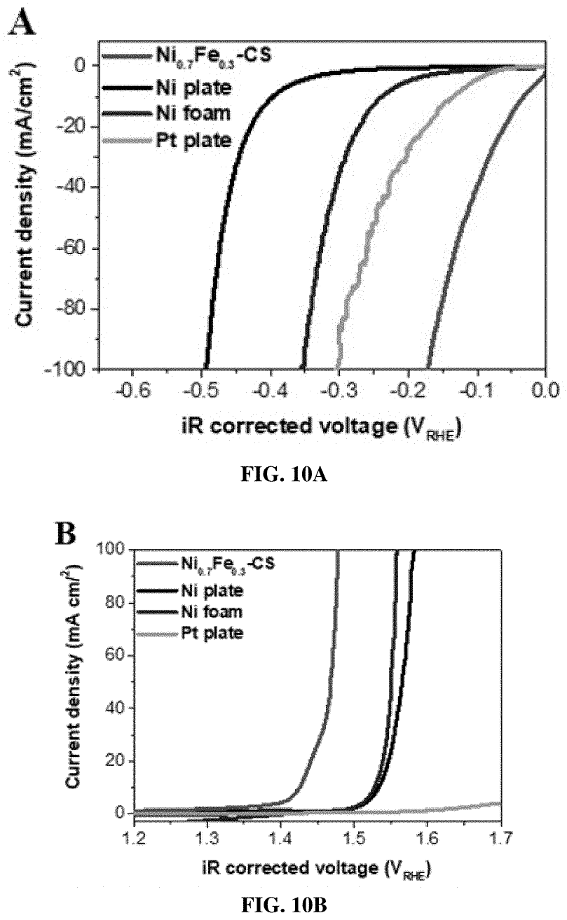

Referring to FIG. 10, which shows the results of comparison with the HER and OER performances of the Ni plate, Ni foam, and Pt plate as bulk substrates, Ni_{0.7}Fe_{0.3}-CS showed the highest activity in HER and OER.

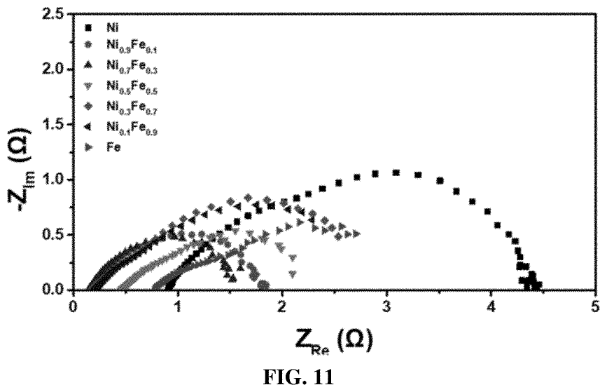

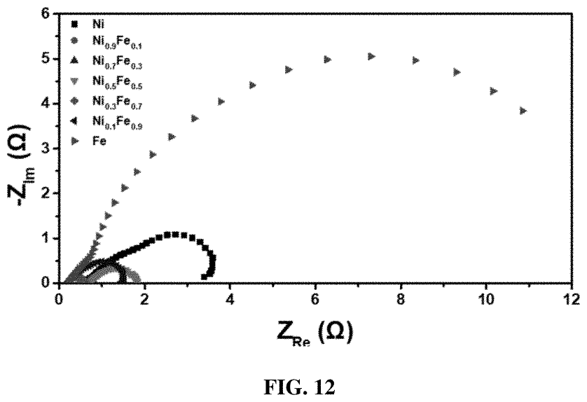

FIGS. 11 and 12 shows the impedance analysis (EIS) results in HER and OER of the NiFe substrate electrodes with different compositions, and it can be seen that Ni0.9Fe0.1 and Ni0.7Fe0.3 showed the smallest impedance arc in both HER and OER. The corresponding impedance patterns are associated with charge transfer resistance, and Ni0.9Fe0.1 and Ni0.7Fe0.3 most facilitate the charge transfer, indicating the highest activity as an electrode. Typical electrodes for alkaline water electrolysis are used by depositing or growing a catalyst on a substrate, and thus the charge transfer resistance between the catalyst and the substrate is large, resulting in a high impedance value. However, the NiFe substrate electrodes manufactured through the present examples showed very low impedance values compared with typical electrodes for alkaline water electrolysis since the substrate itself is used as a high-performance electrode without the use of an additional catalyst, leading to the complete exclusion of the charge transfer resistance between a catalyst and the substrate.

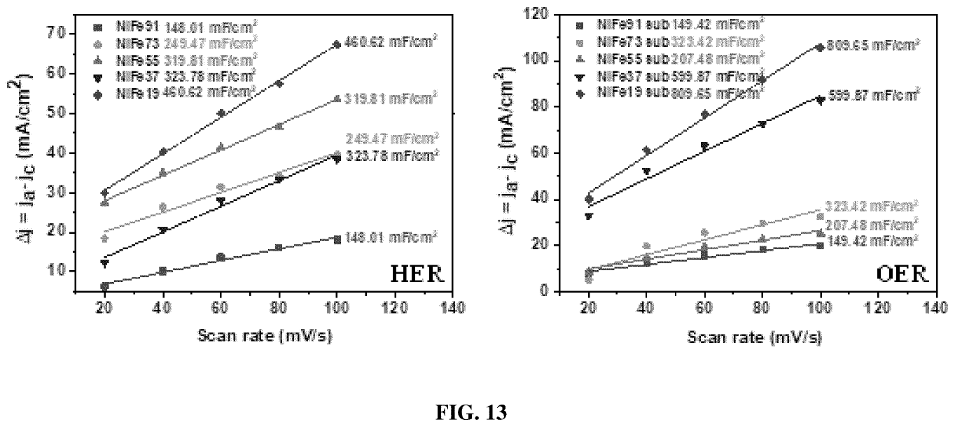

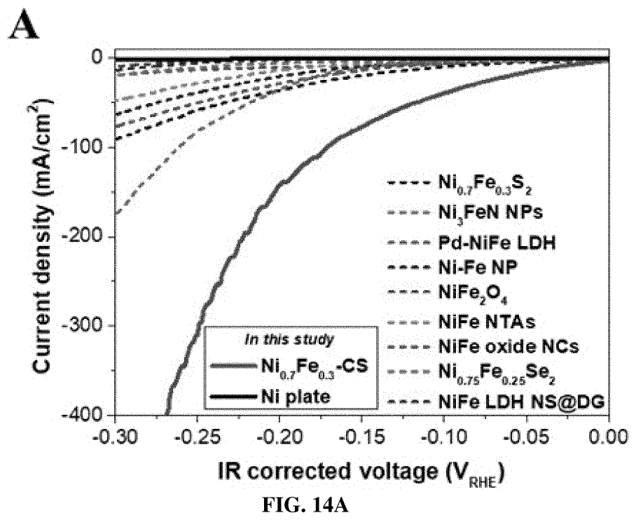

FIG. 13 shows the double layer capacitance measurement results in HER and OER of the NiFe substrate electrodes with different compositions, and depicts graphs showing the oxidation and reduction current density difference according to the scan rate (20, 40, 60, 80, and 100 mV/s) of the NiFe substrate electrodes with different compositions in the −0.2 VHg/HgO (HER) and −0.04 VHg/HgO (OER) regions.

Equation 1 below is an expression showing the relationship between the oxidation and reduction current density difference and the double layer capacitance in cyclic voltammetry (CV) according to the scan rate.

Δj=vC_{dl} [Equation 1]

The actual electrochemical active area of an electrode was calculated by using the double layer capacitance value obtained using the relationship of equation 1 above. As a result, referring to FIG. 13, it can be seen that the electrochemical active area increased as the Fe content in all the NiFe substrate electrodes in both HER and OER.

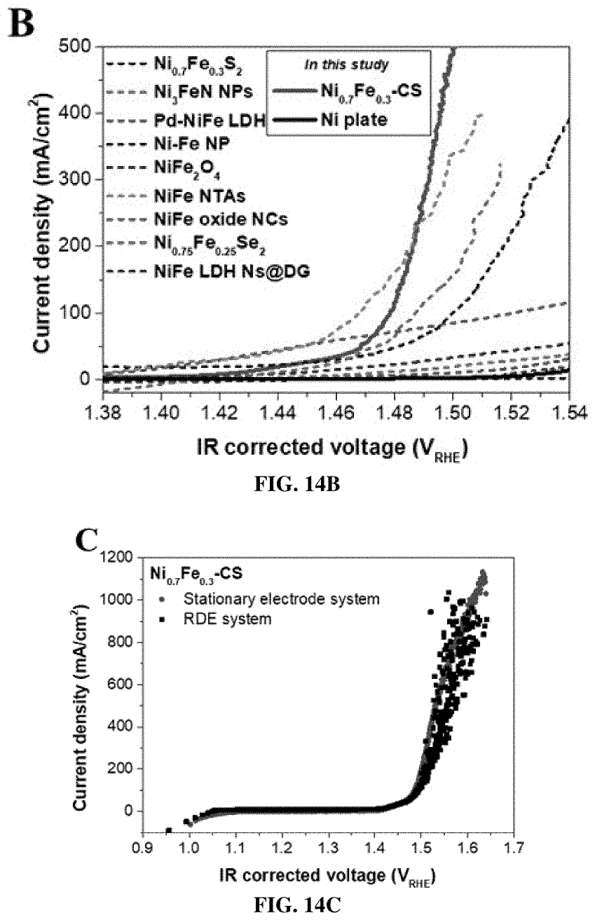

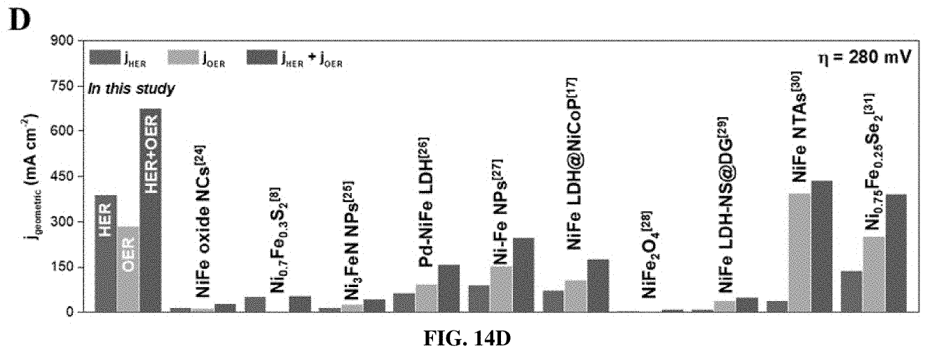

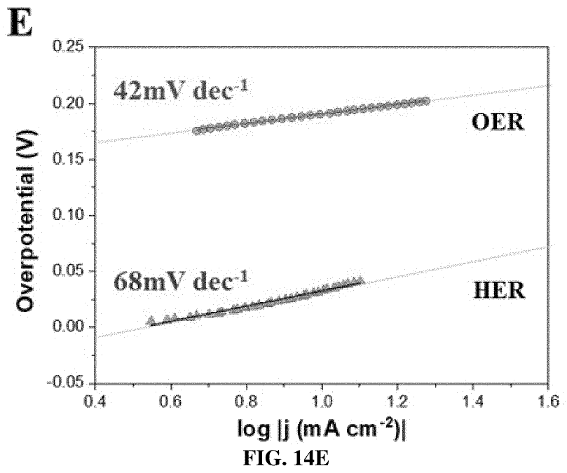

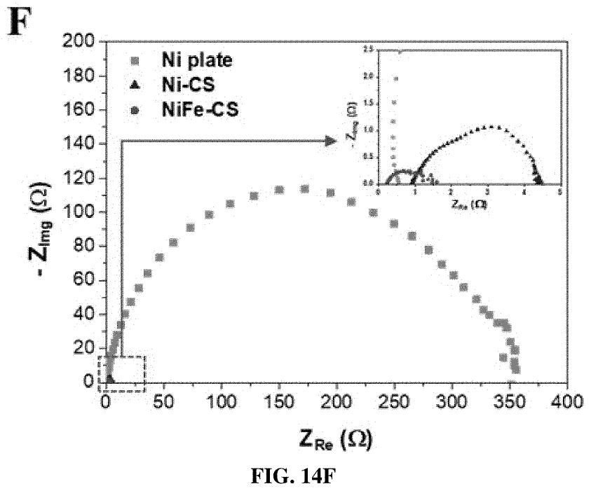

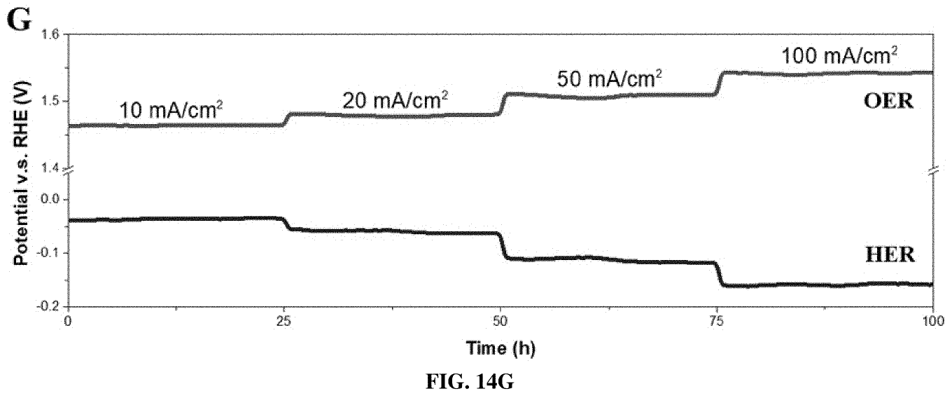

FIGS. 14A and 14B show HER and OER activities of the present example (Ni_{0.7}Fe_{0.3}-CS) and various Ni/Fe-based electrodes, which act as a bifunctional catalyst, when the fixed three-electrode system was used. As can be seen from the drawings, the example of the present disclosure showed significant activities in both HER and OER compared with conventional various Ni/Fe-based electrodes.

Referring to FIG. 14C, in order to investigate the effect of the porous structure of NiFe-CS on the mass transfer, the performance thereof was compared between the fixed electrode system and the RDE system. As a result, the performance of the fixed electrode system was almost similar to that of the RDE system. These results indicate that the electrode performance was not restricted by the effect of mass transfer since the surface areas of the catalyzed substrates manufactured through the methods according to the examples were dramatically increased.

FIG. 14D shows the comparison of the HER/OER performances of Ni_{0.7}Fe_{0.3}-CS with the performance of conventional NiFe-based bifunctional HER/OER catalysts. As a result, Ni_{0.7}Fe_{0.3}-CS showed the highest current densities of 390 mA cm-2 and 287 mA cm-2 at a low overpotential of 280 mV in HER/OER., respectively.

FIG. 14E shows the results of validating the kinetics with a Tafel plot to understand the excellent HER/OER performances. This is an indicator for the rate-determining step (RDS) for electric catalyst reactions. Referring to FIG. 14E, Ni_{0.7}Fe_{0.3}-CS showed Tafel slopes of 68 mV dec-1 and 42 mV dec-1 in HER and OER, respectively, which were lower than the Tafel slopes of Pt/C (30-90 mV dec-1) and IrO2 (46 mV dec-1 or higher), which are representative HER and OER catalysts. These results suggest that the electrodes according to the examples show substantially advantageous catalyst characteristics.

FIG. 14F shows the Nyquist plots of Ni_{0.7}Fe_{0.3}-CS, Ni-CS, and Ni plate in order to investigate the improved catalyst performance of Ni_{0.7}Fe_{0.3}-CS. The semi-circle corresponds to polarization resistance (Rp) including charge transfer resistance (Rct). The Rp values of Ni_{0.7}Fe_{0.3}-CS and Ni-CS were determined to be 1.3 Ω and 3.55 Ω, respectively, which were much smaller than that of the Ni plate (˜358 Ω). The reason why Rp of Ni_{0.7}Fe_{0.3}-CS was smaller than that of Ni-CS was due to Fe metal doping, and it can be seen that the catalyst active site can be improved by changing the local electron structure of the Ni-based catalyst.

The long-term electrochemical stability is another essential parameter for evaluating the performance of a catalyst. Referring to FIG. 14G, the stability of the Ni_{0.7}Fe_{0.3}-CS for HER/OER was identified by multi-phase chronopotentiometry where the current density was changed from 10 to 100 mA cm-2 over 100 hours.

As can be seen from Table 3 below, Ni_{0.7}Fe_{0.3}-CS showed a slight increase in overpotential during long-term HER/OER operations, indicating excellent stability.

TABLE 3

| | Δ °η | Δ °η | Δ °η | Δ °η |
|---|---|---|---|---|
| | (mV) @10 | (mV) @20 | (mV) @50 | (mV) @100 |
| Reaction | mA cm⁻² | mA cm⁻² | mA cm⁻² | mA cm⁻² |
| HER | −3.4 | 8.87 | 8.57 | −1.26 |
| OER | 0.31 | −0.92 | −0.9 | 0 |

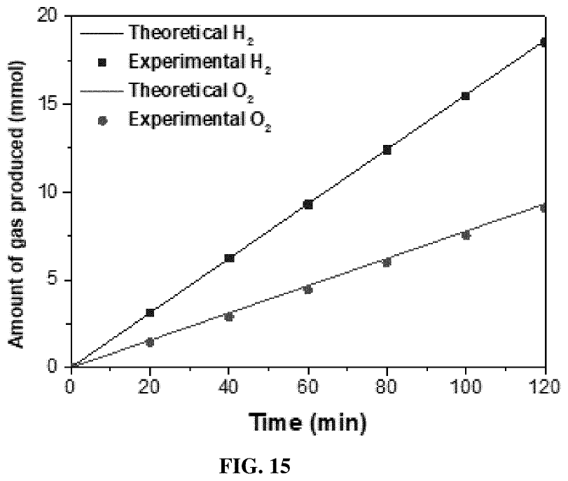

Referring to FIG. 15, Ni_{0.7}Fe_{0.3}-CS showed high faraday efficiencies of 99.3% and 97.2% for HER and OER, respectively, wherein the ratio of hydrogen and oxygen is 2:1. Through these results, it can be identified that water splitting reaction occurred without the loss of other electrons or side effects.

Therefore, NiFe-CS can be estimated as one of the excellent non-noble metal three-dimensional porous electrodes for alkaline water electrolysis, which are operated at a low overpotential for both HER and OER.

### Experimental Example 3—Surface structure analysis

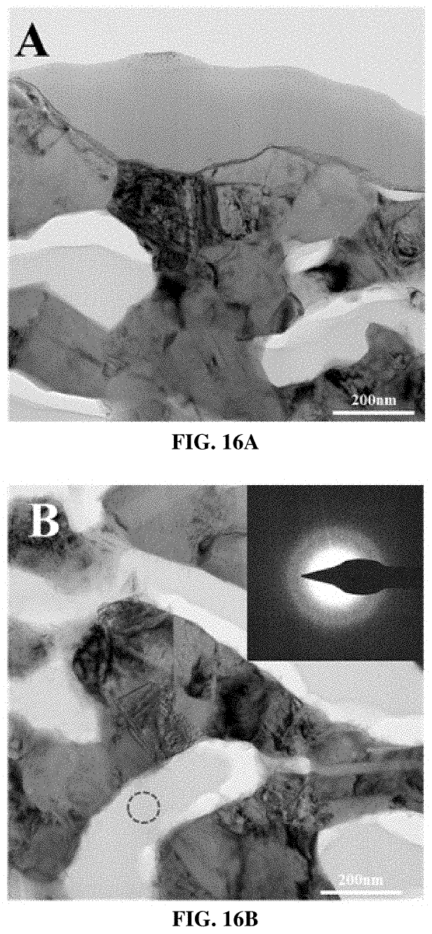

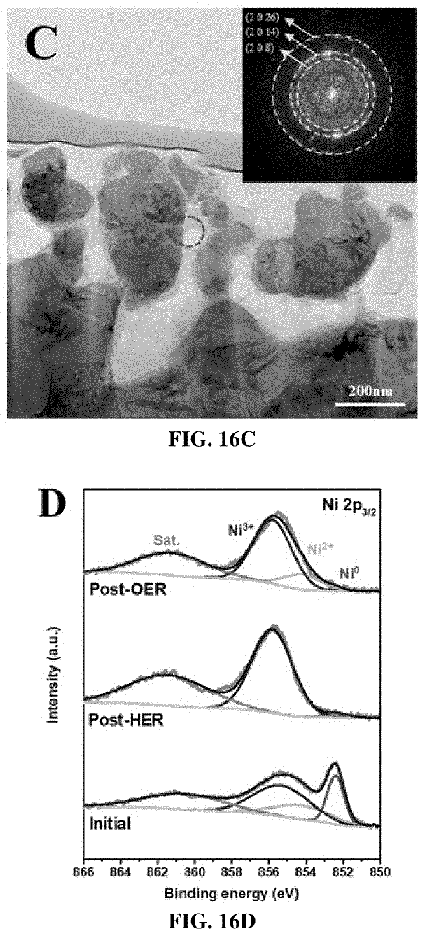

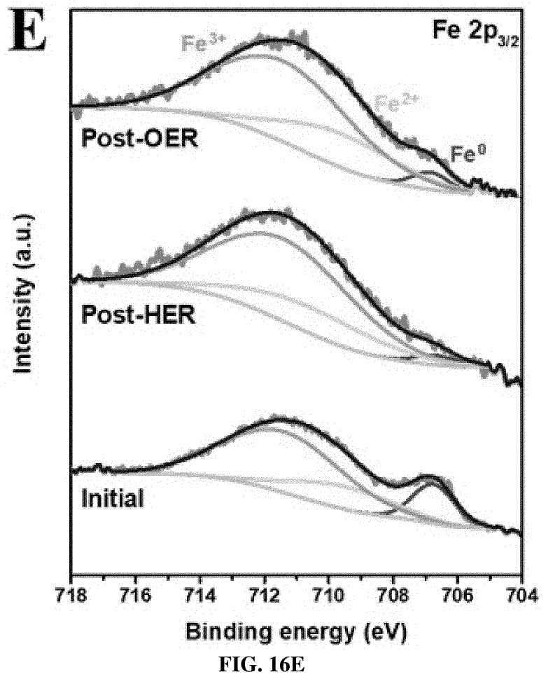

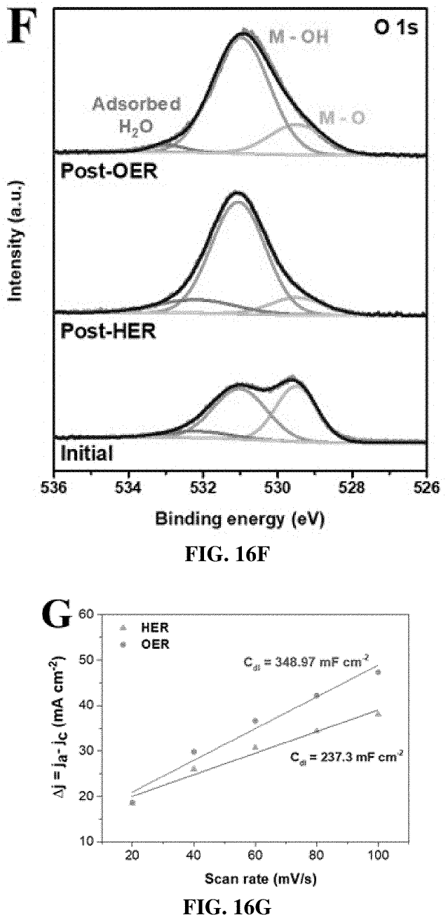

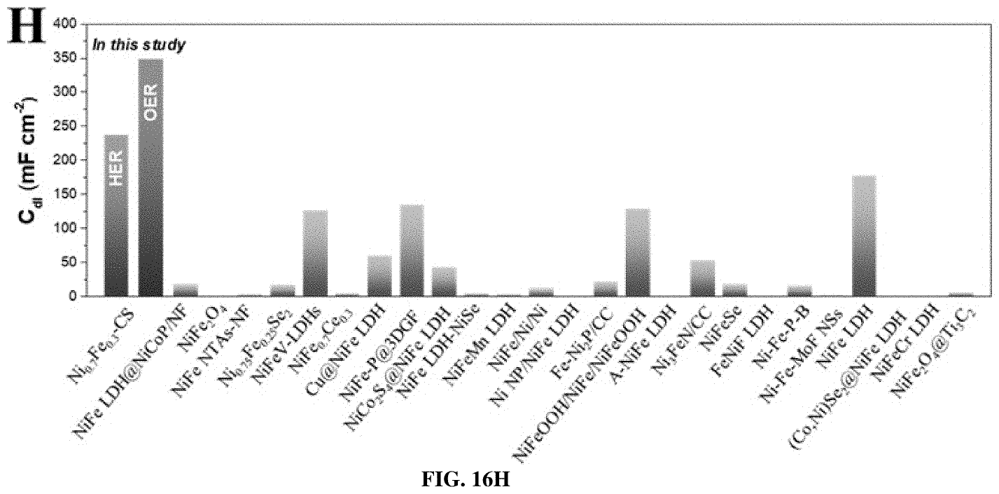

The surface structures of Ni_{0.7}Fe_{0.3}-CS of the fresh sample and post-HER and post-OER samples were analyzed by using TEM and X-ray photoelectron spectroscopy (XPS). FIG. 16A is a TEM image of the fresh sample of Ni_{0.7}Fe_{0.3}-CS, showing a NiFe-alloy frame with abundant pores.

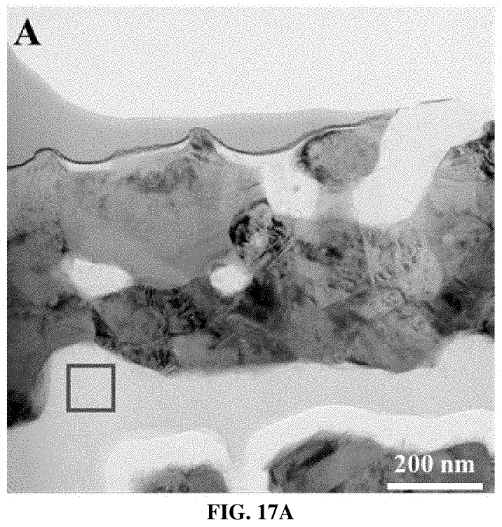

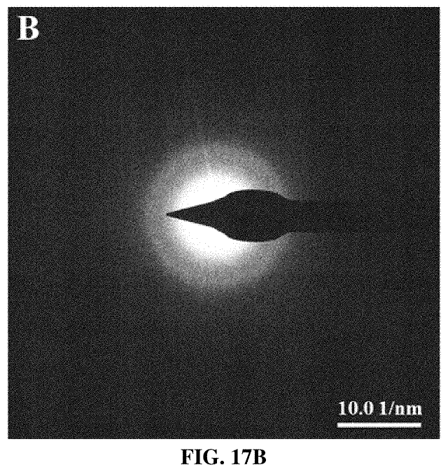

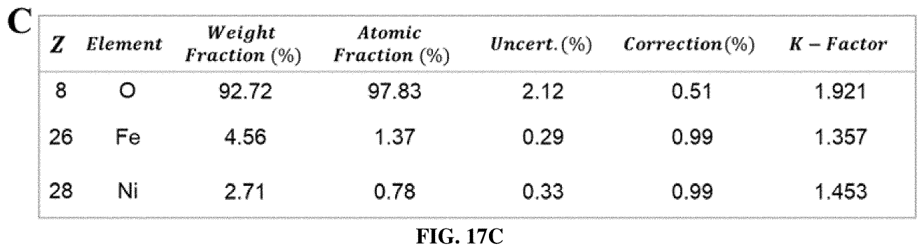

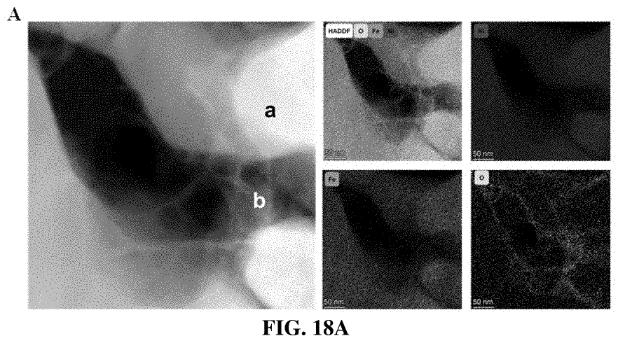

Referring to FIG. 16B, the surface layer of the post-OER NiFe-alloy frame could be confirmed through the SAED pattern, showing no distinctive ring pattern, indicating that an amorphous layer was formed. FIG. 17 shows the post-OER EDS element mapping results. Referring to FIG. 17, oxygen atoms were mainly dominated, indicating that the amorphous phase was composed of hydroxyl species.

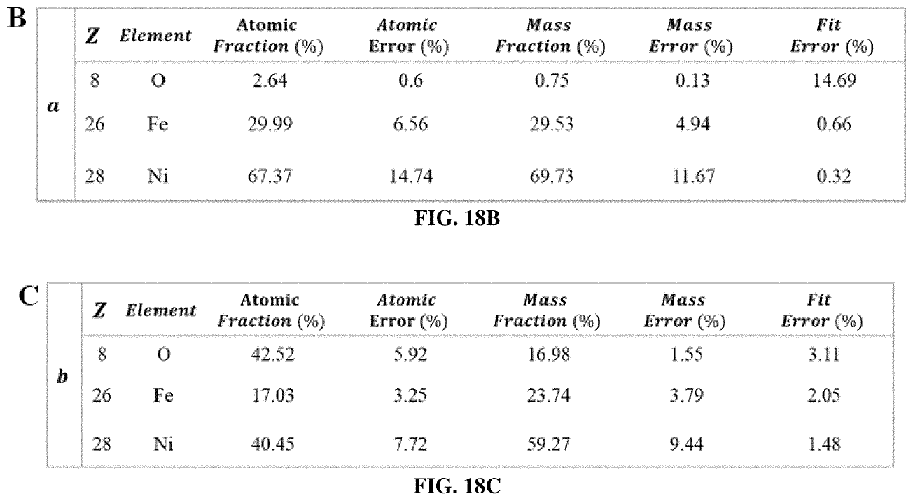

Referring to FIG. 16C, the surface layer of the post-HER sample showed a cross-linked structure, and was identified to have NiFe layered double hydroxide (LDH) by the SAED pattern with three distinctive diffraction faces of (2 0 26), (2 0 14), and (2 0 8). FIG. 18 shows the post-HER EDS element mapping results. Referring to FIG. 18, Fe, Ni, and O elements were uniformly distributed in the NiFe alloy frame, but O is more dominant than Ni and Fe in the NiFe LDH layer.

Referring to FIGS. 16D, 16E, and 16F, the chemical states of the amorphous hydroxyl layer and NiFe LDH phase after OER and HER were confirmed by XPS. The fresh sample showed the presence of Ni0 and Fe0 metal state together with the mixture of oxides and hydroxides. As the metal peaks of Ni and Fe were weakened after the reactions, Ni3+ and Fe3+ were observed to be significantly improved, indicating that a hydroxyl layer and NiFe LDS were formed in the surface. Especially, referring to FIG. 16F, the fresh sample showed two peaks of lattice oxygen (M—O) and hydroxide (M—OH), and the intensity of the hydroxide was dramatically increased after the reaction.

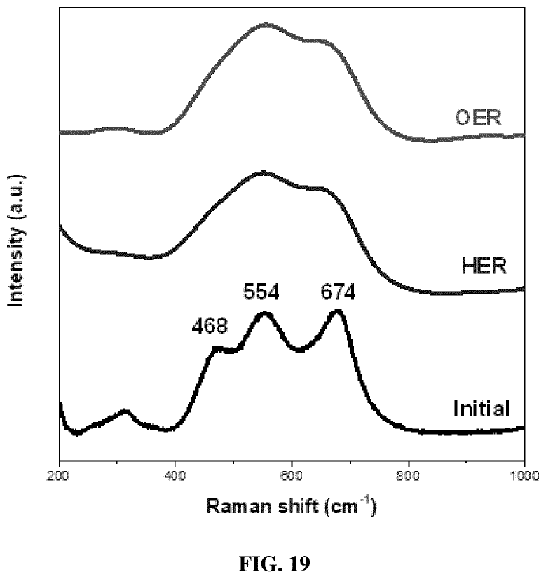

The formation of the amorphous hydroxyl layer could also be confirmed by Raman analysis. FIG. 19 shows the results of comparing Raman spectra of the fresh sample of Ni_{0.7}Fe_{0.3}-CS prepared by low-temperature sintering and reduction and the post-test sample. The fresh sample showed three distinctive hydroxide peaks, 468, 554, and 674 cm-1. The two low-band peaks, ˜468 and 554 cm-1, correspond to Ni-hydroxide, but the high-band peak, ˜674 cm-1, appeared after Fe doping in the Ni sites. Therefore, these features correspond to the random Ni-hydroxide by Fe doping, and at the time of Fe doping, the peak of the Ni-hydroxide was shifted due to the changes of local binding properties. In addition, after the test, the peaks were greatly expanded, indicating that an additional binding structure was formed. In general, the expansion of the Raman peaks may be attributed to the presence of various local bonding structures created by the formation of an amorphous phase and inhomogeneous local environment. Therefore, these results indicate that an amorphous hydroxide was formed during the reaction. NiFe(oxy)hydroxide generally acts as an active phase for both hydrogen and oxygen evolution reactions in alkaline electrolytes, and thus the design to maximize the surface area with hydroxide-forming sites is a key factor for improving electrical catalytic activity by lowering the overpotential.

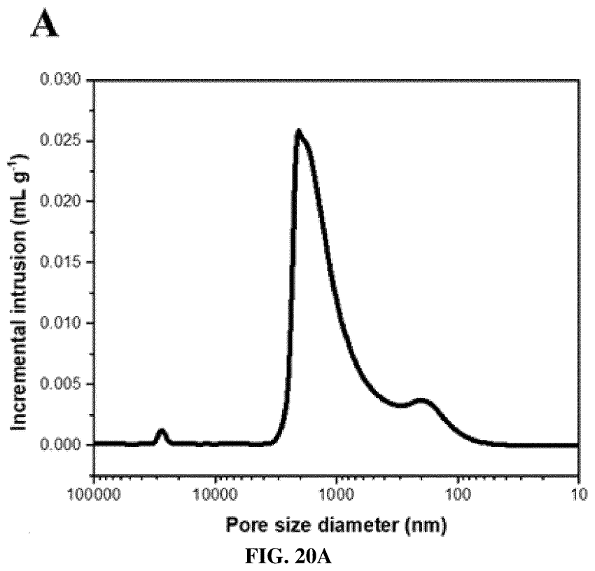

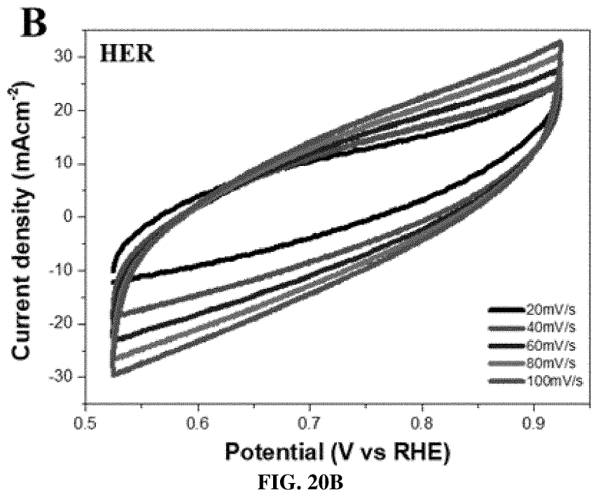

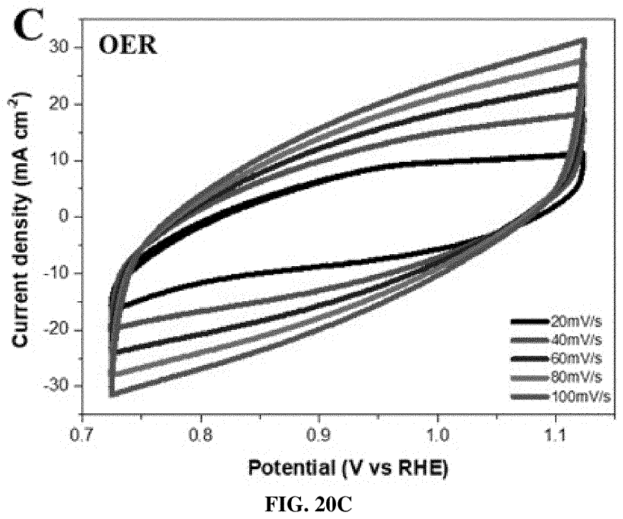

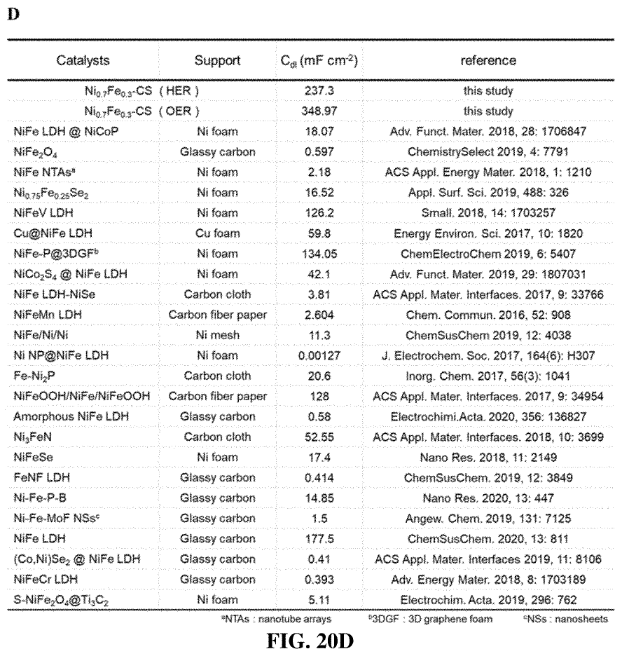

FIG. 16G and FIGS. 20B and 20C show the active surface area estimated by the electrochemical double layer capacitance (Cdl), and is in proportion with electrochemical active surface area (ECSA). Referring to FIGS. 16H and 20D, Ni_{0.7}Fe_{0.3}-CS showed the highest Cdl values, 237.3 mF cm-2 and 348.97 mF cm-2 for HER and OER, respectively, which were much higher compared with other NiFe-based catalysts. Therefore, it can be seen that the electrodes of the present disclosure were catalytically advantageous in the adsorption/desorption of water molecules and the contact with electrolytes. It can be seen that the catalyzed substrate itself of the present disclosure had a much more active surface area compared to other conventional electrodes in which a nano-scale structure catalyst is disposed on a substrate by thermal growth or deposition. Furthermore, the catalyzed substrate of the present disclosure has a porous structure and abundant active sites with excellent charge/mass transfer properties, and these features enable the precise control of catalytic components and can play an important role in dramatically improving HER/OER activity.

Therefore, through the experimental results using the examples of the present disclosure, it can be seen that various process variables capable of improving the performance of electrodes, such as elements, the temperature of reduction, and reaction sites, can be controlled, and furthermore, the possibility of improving the manufacturing and performance of electrodes was presented by additionally grafting various processes, such as dip coating and etching.

As set forth above, the present disclosure has been described with reference to preferable examples. A person skilled in the art to which the present disclosure pertain would understand that the present disclosure could be implemented in a modified form without departing from the inherent characteristics of the present disclosure. Accordingly, the examples described herein should be considered from an illustrative aspect rather than from a restrictive aspect. The scope of the present disclosure should be defined not by the detailed description but by the appended claims, and all differences falling within a scope equivalent to the claims should be construed as being included in the present disclosure.

### INDUSTRIAL APPLICABILITY

The method for manufacturing an electrode for alkaline water electrolysis of the present disclosure attains a simple manufacturing procedure, can produce electrodes with various compositions through the complexation of raw materials, and is advantageous for commercialization due to the facilitation of the manufacturing of large-area electrodes.

What is claimed is:

1. A method for manufacturing an electrode for alkaline water electrolysis, the method comprising:
dissolving a metal salt in a solvent, followed by synthesis, to prepare a wet powder;
performing an oxidative heat treatment on the wet powder; and
performing a reductive heat treatment on the oxidatively heat treated powder.

2. A method for manufacturing an electrode for alkaline water electrolysis, the method comprising:
dissolving a metal salt in a solvent, followed by synthesis, to prepare a wet powder;
gelling the wet powder;
performing a low-temperature heat treatment on the gel to prepare a char;
molding the char to manufacture a substrate;
performing an oxidative heat treatment on the substrate; and
performing a reductive heat treatment on the substrate.

3. The method of claim 1 or 2, wherein the metal salt is a salt of at least one metal selected from the group consisting of Ni, Fe, Co, Mn, Cu, Zn, Mo, Ca, Nb, W, and Ti.

4. The method of claim 1 or 2, wherein in the preparing of the wet powder, the wet powder is prepared by any one selected from the group consisting of a Pechini process, a sol-gel process, and a colloidal process.

5. The method of claim 1 or 2, wherein the oxidative heat treatment is performed in air at a temperature of 300° C. to 700° C. for 30 minutes to 2 hours.

6. The method of claim 1 or 2, wherein the reductive heat treatment is performed under a hydrogen atmosphere at a temperature of 400° C. to 700° C. for 1 to 4 hours.

7. The method of claim 2, wherein the gelling is performed at 70° C. to 90° C.

8. The method of claim 2, wherein the preparing of the char is performed at 300° C. to 700° C.

9. An electrode for alkaline water electrolysis manufactured by the method of claim 1 or 2, wherein the electrode comprises at least one selected from the group consisting of Ni, Fe, Co, Mn, Cu, Zn, Mo, Ca, Nb, W, and Ti and is in a nano-porous form.

10. An electrode for alkaline water electrolysis manufactured by the method of claim 1 or 2, wherein the electrode comprises: a metal selected from the group consisting of Ni, Fe, Co, Mn, Cu, Zn, Mo, Ca, Nb, W, and Ti; and an oxide.

11. The electrode of claim 10, wherein the oxide is at least one selected from the group consisting of alumina (Al₂O₃), zirconia (ZrO₂), TiO₂, [(La₁₋ₓSrₓ)CoO_{3-δ}] (LSC), [(La₁₋ₓSrₓ)FeO_{3-δ}] (LSF), [La₁₋ₓSrₓ)(Co_{1-y}Fe_{y})O_{3-δ}] (LSCF), [(LaₓSr₁₋ₓ)TiO_{3-δ}] (LST), [(BaₓSr₁₋ₓ)(Co_{y}Fe_{1-y})O₃] (BSCF), LaCoO₃, LaNiO₃, (LaₓSr₁₋ₓ)VO₃, Ca(VₓMo₁₋ₓ)O₃, [Ba(ZrₓCe_{y}Y_{1-(x+y)})O₃] (BZCY), and [Pr(Ba₁₋ₓSrₓ)(Fe_{2-y}Ge_{y})O₆] (PBSFG), and in the chemical formulas, 0<x<1, 0<y<1, and 0<δ<3.

12. The electrode of claim 10, wherein the electrode has an average porosity of 50 to 80%.

13. A electrode for alkaline water electrolysis manufactured by the method of claim 2, wherein the electrode comprises NiₓFe₁₋ₓ in which x>0.5, and the electrode is in a nano-porous form.

14. The electrode of claim 13, wherein in the electrode, an amorphous hydroxyl layer is generated during an oxygen evolution reaction (OER).

15. The electrode of claim 13, wherein in the electrode, a layered double hydroxide (LDH) is generated during a hydrogen evolution reaction (HER).
